(19) United States
(12) Patent Application Publication
(10) Pub. No.: US 2025/0297145 A1
(43) Pub. Date: Sep. 25, 2025

(54) SURFACE TOLERANT ADHESIVE

(71) Applicant: Huntsman Advanced Materials Americas LLC, The Woodlands, TX (US)

(72) Inventors: Wenfeng KUANG, The Woodlands, TX (US); Majid SHARIFI, The Woodlands, TX (US); Derek KINCAID, The Woodlands, TX (US); Kevin BIAN, The Woodlands, TX (US); George GUO, The Woodlands, TX (US); Jose TREVINO, The Woodlands, TX (US); Naraso BORJIGIN, The Woodlands, TX (US); Kuanqiang GAO, The Woodlands, TX (US); Michael MORMINO, The Woodlands, TX (US)

(21) Appl. No.: 18/841,435

(22) PCT Filed: Feb. 28, 2023
(86) PCT No.: PCT/US2023/014057

§ 371 Date: Aug. 26, 2024

Related U.S. Application Data
(60) Provisional application No. 63/315,218, filed on Mar. 1, 2022.

(51) Int. Cl. C09J 11/08; B32B 5/02; B32B 5/26; B32B 7/12; C09J 5/00; C09J 133/04; C09J 163/00; C09J 175/02; C09J 175/04

(52) U.S. Cl. CPC C09J 11/08; B32B 5/02; B32B 5/26; B32B 7/12; C09J 5/00; C09J 133/04; C09J 163/00; C09J 175/02; C09J 175/04; B32B 2250/02; B32B 2250/20; B32B 2255/02; B32B 2260/023; B32B 2260/046

(57) ABSTRACT

The present disclosure provides a composition including a curable resin, a curing agent and surface modifying agent such as a reactive siloxane, a reactive fluoro compound or a mixture thereof. The composition is tolerant to various contaminants typically found on surfaces of substrates, such as silicone, and is therefore able to attach to substrate having such contaminants on its surface and provide improved adhesion performance.

### CROSS-REFERENCE TO RELATED APPLICATION

This application is a national phase of International Application No. PCT/US2023/014057 filed Feb. 28, 2023, which designates the U.S and claims priority to U.S. Provisional Patent Application Ser. No. 63/315,218, filed Mar. 1, 2022. The noted applications are incorporated herein by reference.

### STATEMENT REGARDING FEDERALLY SPONSORED RESEARCH AND DEVELOPMENT

This invention was made with the United States Government support under cooperative agreement number W911W6-13-2-0004 awarded by the Research Development and Engineering Command (DOD-Army-AMC). The United States Government has certain rights in this invention.

### FIELD

The present disclosure generally relates to compositions for use as an adhesive, sealant or coating and having a high tolerance to various contaminants typically found on the surface of a substrate. In particular, the present disclosure relates to a composition containing a curable resin, a curing agent and a surface modifying agent selected from a reactive siloxane, a reactive fluoro compound, and a mixture thereof.

### BACKGROUND

Since adhesives and sealants must function by surface attachment, the nature and condition of the substrate surface are important to the success of any bonding or sealing operation. One of the most important parameters is surface cleanliness or the absence of contaminants that can impair adhesion.

One such known contaminant is silicone. Silicones are unusual materials because they prevent formation of reliable bonds. Silicones have low surface energy, so they wet most surfaces extremely well. As a result, silicone-based adhesives and sealants show a high degree of wetting and adhesion on most practical surfaces. Certain silicone materials are even used as adhesion promoters in many formulations. However, problems can occur once the silicone (either liquid or solid) is on the substrate surface. Because it has a low surface energy, other adhesives, sealants, or coatings will not wet or bond to the silicone surface. The presence of silicone on a substrate results in the formation of a “weak boundary layer” which prevents a direct contact between the adhesive or sealant and the substrate that can lead to adhesion failure. Silicone contamination problems are not limited to only adhesives and sealants. Trace amounts of silicone can cause primers, paints, or other coatings to “fisheye”, separate, and lose adhesion.

There are many sources of silicone contamination including mold release agents, tapes, lubrication oils, and other silicone adhesives and sealants. Their presence, even in quantities so minute that they are difficult to detect, can cause havoc with other adhesive and coating systems. Silicone contamination can also be spread by direct physical contact with materials or equipment as many creams, cosmetics, hair products, antiperspirants and some eye-glass cleaning tissues contain silicones. High volatility of certain silicone-containing compounds can also promote cross contamination of the bonding surface without direct contact with the surface. For example, serious coating problems have occurred in auto finishing operations where silicone mold release used in one part of the plant can be transmitted through air ducts to surfaces being painted in other parts of the plant.

Cleaning silicone contaminated substrates using a solvent wipe method generally improves the subsequent bond performance, but rarely brings the performance back to the baseline.

Grit blasting might also be considered as a potential method for cleaning a silicone contaminated surface. However, blast media may become contaminated with the silicone and transfer the contamination to other pieces that are waiting to be cleaned. If a strict procedure of solvent washing, then blasting, followed by another solvent washing is not followed, the contamination can be driven deeper into the substrate making it more difficult to remove creating the potential that the bond strength may look adequate initially but will degrade with service.

CO₂ jet spray has also been investigated for large surfaces such as solar cells. While the jet spray appears successful in achieving visibly clean surfaces, silicones are only partially soluble in CO₂ and some remaining residue is likely. Other known surface treatments to increase surface free energy include chemical/acid treatment, flame treatment and plasma/corona treatment. However, cleaning or degreasing is still recommended as a pretreatment for the surface since weak boundary layers are still a matter of concern.

Therefore, a need exists to further improve upon the state of the art by utilizing a new adhesive or sealant that is silicone tolerant and thus capable of providing a reliable bond, even in the presence of silicone contaminants, with minimal or no pretreatment of the surface.

### SUMMARY

The present disclosure generally provides a composition for use as an adhesive, sealant or coating including (a) a curable resin, (b) a curing agent, and (c) a surface modifying agent selected from a reactive siloxane, a reactive fluoro compound, and a mixture thereof.

The present disclosure also provides a laminate structure including a first substrate bonded to a second substrate and a cured structural adhesive film between the first and second substrates, where the structural adhesive film is formed from the composition of the present disclosure. The laminate structure may be used in automotive and aerospace applications.

### BRIEF DESCRIPTION OF THE DRAWINGS

FIG. 1 depicts the lap shear strength of adhesives according to the present disclosure and a control adhesive at room temperature;

FIG. 2 depicts the lap shear strength of adhesives according to the present disclosure and a control adhesive on contaminated (hatched bars) and uncontaminated (solid bars) composite adherends at elevated temperature (ETD) and low temperature (LT); and

FIG. 3 depicts the strain energy release rate (Gic) values of adhesives according to the present disclosure and a control adhesive in contaminated (hatched bars) and uncontaminated (solid bars) CFRP substrates.

### DETAILED DESCRIPTION

The present disclosure generally provides a composition comprising (a) a curable resin, (b) a curing agent, and (c) a surface modifying agent selected from the group consisting of a reactive siloxane, a reactive fluoro compound, and a mixture thereof. It has been surprisingly found that the surface modifying agent is capable of modifying the surface properties of the composition allowing it to be chemically compatible with contaminants typically found on the surface of a substrate, such as silicone, which are known to substantially degrade adhesive joint performance between the composition and the surface. In particular, the surface modifying agent lowers the surface energy of the composition such that it is lower than the attractive forces between the composition and contaminated surface which allows it to spread and make intimate contact with the surface which results in a higher bond strength between the composition and surface.

The following terms shall have the following meanings:

The term “surface modifying agent” refers to a surface active material within a composition that tends to appear at the surface of the composition, thus changing the properties of the composition's surface. For example, the surface modifying agent as disclosed herein creates a hydrophobic surface, thus controlling compatibility of the composition with a wide variety of contaminants, such as silicone, typically found on the surface of a substrate to which the composition may be applied.

The term “(meth)acrylic” can mean acrylic or methacrylic, “(meth)acryloyl” can mean acryloyl or methacryloyl, and “(meth)acrylate” can mean acrylate or methacrylate. Furthermore, “acrylic resin” can mean a resin obtained by polymerizing a monomer ingredient including at least one kind of (meth)acrylic monomer.

The term “perfluoro group” means a hydrocarbon group in which all the hydrogen atoms bonded to a carbon atom are substituted with fluorine atoms. In some instances, the perfluoro group may contain an ether bond. For example, the perfluoro group may be a perfluoroalkyl group having 1 to 14 carbon atoms, or 1 to 6 carbon atoms, or 1 to 3 carbon atoms or a perfluoroalkylene group having 2 to 12 carbon atoms or 2 to 6 carbon atoms.

In some embodiments the perfluoro group may by represented by one or more of the following formulas

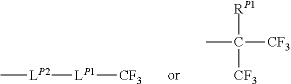

where L^{P1} represents a single bond or a linking group having an alkyl group, which may be substituted with a halogen atom, and having 2 to 36 carbon atoms or 2 to 18 carbon atoms or a linking group containing an oxygen atom within the chain of such an alkyl group, L^{P2} represents a single bond or an alkyl group having 1 to 12 carbon atoms or 1 to 6 carbon atoms or 1 to 3 carbon atoms, an alkenyl group having 2 to 12 carbon atoms or 2 to 6 carbon atoms or 2 or 3 carbon atoms, an alkynyl group having 2 to 12 carbon atoms or 2 to 6 carbon atoms or 2 or 3 carbon atoms, an aralkyl group having 7 to 15 carbon atoms or 7 to 11 carbon atoms, an aryl group having 6 to 14 carbon atoms or 6 to 10 carbon atoms, a hydroxyl group, or an alkoxy group having 1 to 6 carbon atoms or 1 to 4 carbon atoms, and R^{P1} represents a hydrogen atom, an alkyl group having 1 to 12 carbon atoms, for example 1 to 6 carbon atoms, or 1 to 3 carbon atoms, or a halogen atom, for example, a fluorine atom.

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article. By way of example, “an epoxy resin” means one epoxy resin or more than one epoxy resin.

The phrases “in one embodiment”, “according to one embodiment” and the like generally mean the particular feature, structure, or characteristic following the phrase is included in at least one aspect of the present disclosure, and may be included in more than one embodiment of the present disclosure. Importantly, such phrases do not necessarily refer to the same embodiment.

If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

According to one embodiment, the present disclosure provides a composition that generally includes (a) a curable resin, (b) a curing agent, and (c) a surface modifying agent selected from the group consisting of a reactive siloxane, a reactive fluoro compound, and a mixture thereof. In some embodiments, the composition is an adhesive, for example, a structural adhesive, or a sealant, or a coating.

In one embodiment, the curable resin may be an epoxy resin, an acrylic resin, a polyurethane/polyurea resin or a mixture thereof. In one particular embodiment, the curable resin is an epoxy resin.

In general, any epoxy-containing compound is suitable for use as the epoxy resin in the present disclosure, such as the epoxy-containing compounds disclosed in U.S. Pat. No. 5,476,748 which is incorporated herein by reference. According to one embodiment, the epoxy resin is selected from a difunctional epoxy resin (thus having two epoxide groups), a trifunctional epoxy resin (thus having three epoxide groups), a tetrafunctional epoxy resin (thus having four epoxide groups) and a mixture thereof.

Illustrative non-limiting examples of difunctional epoxy resins are: bisphenol A diglycidyl ether, bisphenol F diglycidyl ether, tetrabromobisphenol A diglycidyl ether, propylene glycol diglycidyl ether, butylene glycol diglycidyl ether, ethylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropylene glycol diglycidyl ether, 3,4-epoxycyclohexylmethyl carboxylate, hexahydrophthalic acid diglycidyl ester, methyltetrahydrophthalic acid diglycidyl ester and mixtures thereof. In some embodiments, the difunctional epoxy resin may be modified with a monofunctional reactive diluent, such as, but not limited to, p-tertiary butyl phenol glycidyl ether, cresyl glycidyl ether, 2-ethylhexyl glycidyl ether, and C₈-C₁₄ glycidyl ether.

Illustrative non-limiting examples of trifunctional epoxy resins include those based on bisphenol F, bisphenol A (optionally brominated), phenol and cresol epoxy novolacs, glycidyl ethers of phenol-aldelyde adducts, aromatic epoxy resins, dialiphatic triglycidyl ethers, aliphatic polyglycidyl ethers, epoxidised olefins, brominated resins, aromatic glycidyl amines, heterocyclic glycidyl imidines and amides, glycidyl ethers, fluorinated epoxy resins. Particular examples include triglycidyl ether of para-aminophenol, triglycidyl ether of meta-aminophenol, dicyclopentadiene based epoxy resins, N,N,O-triglycidyl-4-amino-m- or5-amino-o-cresol type epoxy resins, and a 1,1,1-(triglycidyloxyphenyl) methane type epoxy resin.

Illustrative non-limiting examples of tetrafunctional epoxy resins are: N,N,N′,N′-tetraglycidyl methylene dianiline, N,N,N′,N′-tetraglycidyl-m-xylenediamine, tetraglycidyl diaminodiphenyl methane, sorbitol polyglycidyl ether, pentaerythritol tetraglycidyl ether, tetraglycidyl bisamino methyl cyclohexane and tetraglycidyl glycoluril.

Examples of commercially available epoxy resins which may be used include, but are not limited to, ARALDITE® PY 306 epoxy resin (an unmodified bisphenol-F based liquid epoxy resin), ARALDITE® MY 721 epoxy resin (a tetrafunctional epoxy resin based on methylene dianiline), ARALDITE® MY 0510 epoxy resin (a trifunctional epoxy resin based on para-aminophenol), ARALDITE® MY 0610 epoxy resin (a trifunctional epoxy resin based on meta-aminophenol), ARALDITE® GY 6005 epoxy resin (a bisphenol-A based liquid epoxy resin modified with a monofunctional reactive diluent), ARALDITE® 6010 epoxy resin (a bisphenol-A based liquid epoxy resin), ARALDITE® MY 06010 epoxy resin (a trifunctional epoxy resin based on meta-aminophenol), ARALDITE® GY 285 epoxy resin (an unmodified bisphenol-F based liquid epoxy resin), ARALDITE® EPN 1138, 1139 and 1180 epoxy resins (epoxy phenol novolac resins), ARALDITE® ECN 1273 and 9611 epoxy resins (epoxy cresol novolac resins), ARALDITE® GY 289 epoxy resin (an epoxy phenol novolac resin), ARALDITE® PY 307-1 epoxy resin (an epoxy phenol novolac resin) and mixtures thereof.

In one embodiment, the amount of the epoxy resin present in the composition may be an amount of between about 10 wt. % to about 90 wt. %, or between about 20 wt. % to about 75 wt. %, or between about 30 wt. % to about 60 wt. %, or between about 40 wt. % to about 50 wt. %, based on the total weight of the composition. In another embodiment, the amount of the epoxy resin present in the composition may be an amount of between about 50 wt. % to about 95 wt. %, or between about 65 wt. % to about 90 wt. %, based on the total weight of the composition.

According to another embodiment, the curable resin is an acrylic resin. The acrylic resin is a resin obtained by copolymerizing comonomer ingredients which include at least one (meth)acrylic acid alkyl ester monomer (a1) as a main component and which optionally includes at least one functional-group-containing monomer (a2) and at least one other copolymerizable monomer (a3) as needed.

In one embodiment, the (meth)acrylic acid alkyl ester monomer (a1) is a monomer in which the number of carbon atoms of the alkyl group is between 1 to 20, or between 1 to 12, or between 1 to 8, or even between 4 to 8. Specific examples of (a1) include, but are not limited to, methyl (meth)acrylate, ethyl (meth)acrylate, n-butyl (meth)acrylate, iso-butyl (meth)acrylate, tert-butyl (meth)acrylate, n-propyl (meth)acrylate, n-hexyl (meth)acrylate, 2-ethylhexyl (meth)acrylate, n-octyl (meth)acrylate, iso-octyl acrylate, iso-decyl (meth)acrylate, lauryl (meth)acrylate, cetyl (meth)acrylate, stearyl (meth)acrylate, iso-stearyl acrylate and mixtures thereof.

The content of the (meth)acrylic acid alkyl ester monomer (a1) in the comonomer ingredients in some embodiments may be between about 10-100% by weight, or between about 20-95% by weight, or between about 40-95% by weight, or between about 60-95% by weight, based on the total weight of comonomer ingredients.

Examples of the functional-group-containing monomer (a2) include, but are not limited to, hydroxyl-group-containing monomers, carboxyl-group-containing monomers, amino-group-containing monomers, acetoacetyl-group-containing monomers, isocyanate-group-containing monomers, glycidyl-group-containing monomers and mixtures thereof. In some embodiments, the hydroxyl-group-containing monomers and carboxyl-group-containing monomers are preferred.

Examples of the hydroxyl-group-containing monomers include, but are not limited to: hydroxyalkyl esters of acrylic acid, such as 2-hydroxyethyl (meth)acrylate, 4-hydroxybutyl (meth)acrylate, 5-hydroxypentyl (meth)acrylate, 6-hydroxyhexyl (meth)acrylate, and 8-hydroxyoctyl (meth)acrylate; caprolactone-modified monomers such as caprolactone-modified 2-hydroxyethyl (meth)acrylates; oxyalkylene-modified monomers such as diethylene glycol (meth)acrylate and polyethylene glycol (meth)acrylate; monomers containing a primary hydroxyl group, such as 2-acryloyloxyethyl-2-hydroxyethylphthalic acid; monomers containing a secondary hydroxyl group, such as 2-hydroxypropyl (meth)acrylate, 2-hydroxybutyl (meth)acrylate, and 3-chloro-2-hydroxypropyl (meth)acrylate; and monomers containing a tertiary hydroxyl group, such as 2,2-dimethyl-2-hydroxyethyl (meth)acrylate.

Examples of the carboxyl-group-containing monomers include, but are not limited to, (meth)acrylic acid, acrylic acid dimer, crotonic acid, maleic acid, maleic anhydride, fumaric acid, citraconic acid, glutaconic acid, itaconic acid, acrylamido-N-glycolic acid, and cinnamic acid.

Examples of the amino-group-containing monomers include tert-butylaminoethyl (meth)acrylate, ethylaminoethyl (meth)acrylate, dimethylaminoethyl (meth)acrylate, and diethylaminoethyl (meth)acrylate.

Examples of the acetoacetyl-group-containing monomers include 2-(acetoacetoxy)ethyl (meth)acrylate and allyl acetoacetate.

Examples of the isocyanate-group-containing monomers include 2-acryloyloxyethyl isocyanate, 2-methacryloyloxyethyl isocyanate, and alkylene oxide adducts of these.

Examples of the glycidyl-group-containing monomers include glycidyl (meth)acrylate and allylglycidyl (meth)acrylate.

The content of the functional-group-containing monomer (a2) in the comonomer ingredients may be between about 0.01-30% by weight, or between about 0.05-10% by weight, or between about 0.1-10% by weight, or between about 2-5% by weight, based on the total weight of the comonomer ingredients.

Examples of the other copolymerizable monomer (a3) include, but are not limited to: (meth)acrylate compounds containing an alicyclic structure, such as cyclohexyl (meth)acrylate and isobornyl (meth)acrylate; monomers containing one aromatic ring, such as phenyl (meth)acrylate, benzyl (meth)acrylate, phenoxyethyl (meth)acrylate, phenyldiethylene glycol (meth)acrylate, 2-hydroxy-3-phenoxypropyl (meth)acrylate, styrene, and α-methylstyrene; (meth)acrylic acid ester monomers containing a biphenyloxy structure, such as biphenyloxyethyl (meth)acrylate; (meth)acrylamide monomers such as ethoxymethyl(meth)acrylamide, n-butoxymethyl (meth)acrylamide, (meth)acryloylmorpholine, dimethyl (meth)acrylamide, diethyl(meth)acrylamide, and (meth)acrylamido-N-methylol(meth)acrylamide; monomers containing an alkoxy group or oxyalkylene group, such as 2-methoxyethyl (meth)acrylate, 2-ethoxyethyl (meth)acrylate, methoxydiethylene glycol (meth)acrylate, ethoxydiethylene glycol (meth)acrylate, methoxypolyethylene glycol (meth)acrylate, and polypropylene glycol mono(meth)acrylate; and acrylonitrile, methacrylonitrile, vinyl acetate, vinyl propionate, vinyl stearate, vinyl chloride, vinylidene chloride, alkyl vinyl ethers, vinyltoluene, vinylpyridine, vinylpyrrolidone, itaconic acid dialkyl esters, fumaric acid dialkyl esters, allyl alcohol, acrylic chloride, methyl vinyl ketone, allyltrimethylammonium chloride, dimethylallyl vinyl ketone and mixtures thereof.

The content of the other copolymerizable monomer (a3) in the comonomer ingredients may be between about 0-40% by weight, or between about 0-30% by weight, or between about 0-25% by weight, based on the total weight of the comonomer ingredients.

The acrylic resin can be produced by polymerizing, such as by solution polymerization, the (meth)acrylic acid alkyl ester monomer (a1), the functional-group-containing monomer (a2) and the other co-polymerizable monomer (a3) as needed, as comonomer ingredients.

For example, solution polymerization may be performed by mixing or dropping monomer ingredients including the (meth)acrylic acid alkyl ester monomer (a1), functional-group-containing monomer (a2), and other co-polymerizable monomer (a3) and a polymerization initiator with or into an organic solvent and polymerizing the monomer ingredients under a refluxing condition or at a temperature between about 50° to 98° C. for about 0.1 to 20 hours.

Specific examples of the polymerization initiator include ordinary radical polymerization initiators, such as azo type polymerization initiators, for example, azobisisobutyronitrile and azobisdimethylvaleronitrile, and peroxide type polymerization initiators, for example, benzoyl peroxide, lauroyl peroxide, di-tert-butyl peroxide, and cumene hydroperoxide.

In some embodiments, the weight-average molecular weight of the acrylic resin may be between about 100,000-5,000,000 Daltons, or between about 300,000-1,500,000 Daltons, or between about 500,000-900,000 Daltons.

In some embodiments, the amount of the acrylic resin present in the composition may be an amount between about 10 wt. % to about 90 wt. %, or between about 20 wt. % to about 75 wt. %, or between about 30 wt. % to about 60 wt. %, or between about 40 wt. % to about 50 wt. %, based on the total weight of the composition. In another embodiment, the amount of the acrylic resin present in the composition may be an amount between about 50 wt. % to about 95 wt. %, or between about 65 wt. % to about 90 wt. %, based on the total weight of the composition.

In another embodiment, the curable resin is a polyurethane/polyurea resin which has a urea bond (—R—NH—CO—NH—) in its molecular chain. Any known polyurethane/polyurea resin may be used. In one embodiment, the polyurethane/polyurea resin is a reaction product of (A) a urethane prepolymer having an isocyanate group at the end of the molecule, (B) a polyamine compound having at least two amino groups in the molecule and (C) a compound having one group capable of reacting with an isocyanate group in the molecule.

In one embodiment, the (A) urethane prepolymer having an isocyanate group in the molecule is a reaction product of (A1) at least one polyol compound having at least two hydroxyl groups, such as a polycarbonate polyol, a polyether polyol, a polyester polyol, and a polycaprolactone polyol and (A2) a diisocyanate compound having two isocyanate groups in the molecule.

The number of hydroxyl groups contained in one molecule of the above (A1) polyol compound may be 2 to 6 or 2 to 3. Additionally, the above-noted polyether polyols, polyester polyols, polycarbonate polyols and polycaprolactone polyols may be used alone or in combination of two or more.

Examples of polycarbonate polyols may include, but are not limited to, polycarbonate polyols obtained by phosgenating at least one low-molecular weight polyol such as ethylene glycol, 1,2-propanediol, 1,3-propanediol, 2-methyl-1,3-propanediol, 1,2-butanediol, 1,3-butanediol, 1,4-butanediol, 1,5-pentanediol, 1,6-hexanediol, 1,8-octanediol, 1,9-nonanediol, 1,10-decanediol, 3-methyl-1,5-pentanediol, 2-ethyl-4-butyl-1,3-propanediol, diethylene glycol, dipropylene glycol, neopentyl glycol, cyclohexane-1,4-diol, cyclohexane-1,4-dimethanol, dimeric acid diol, ethylene oxide or propylene oxide adduct of bisphenol A, bis(β-hydroxyethyl)benzene, xylylene glycol, glycerin, trimethylolpropane or pentaerythritol or by transesterifying a low-molecular weight carbonate such as ethylene carbonate, diethyl carbonate or diphenyl carbonate. The number average molecular weight of the polycarbonate polyol may be between about 400-2,000 g/mol, or between about 500-1,500 g/mol, or between about 600-1,200 g/mol.

Examples of polyether polyols include, but are not limited to, polyether polyols obtained from a reaction between a compound having at least two active hydrogen-containing groups in the molecule and an alkylene oxide, polymer polyols which are modified products of the polyether polyol compounds, urethane modified polyether polyols and polyether ester copolymer polyols.

Examples of the compound having at least two active hydrogen-containing groups in the molecule include polyols such as glycols and glycerin having at least one hydroxyl group in the molecule exemplified by water, ethylene glycol, propylene glycol, butanediol, glycerin, trimethylolpropane, hexane triol, triethanolamine, diglycerin, pentaerythrytol, trimethylolpropane, hexane triol and mixtures thereof.

Examples of the above alkylene oxide include ethylene oxide, propylene oxide and cyclic ether compounds such as tetrahydrofuran, and mixtures thereof.

The number average molecular weight of the polyether polyol may be between about 400-2,000 g/mol, or between about 500-1,500 g/mol, or between about 600-1,200 g/mol.

Examples of polyester polyols include, but are not limited to, polyester polyols obtained from a condensation reaction between a polyhydric alcohol and a polybasic acid. Examples of the above polyhydric alcohol include ethylene glycol, 1,2-propanediol, 1,3-butanediol, 1,4-butanediol, 3-methyl-1,5-pentanediol, 1,6-hexanediol, 3,3′-dimethylolheptane, 1,4-cyclohexane dimethanol, neopentyl glycol, 3,3-bis(hydroxymethyl) heptane, diethylene glycol, dipropylene glycol, glycerin, trimethylol propane and mixtures thereof. Examples of the above polybasic acid include succinic acid, adipic acid, azelaic acid, sebacic acid, dodecanedicarboxylic acid, cyclopentanedicarboxylic acid, cyclohexanedicarboxylic acid, orthophthalic acid, isophthalic acid, terephthalic acid, naphthalene dicarboxylic acid and mixtures thereof.

The number average molecular weight of the polyester polyol may be between about 400-2,000 g/mol, or between about 500-1,500 g/mol, or between about 600-1,200 g/mol.

The polycaprolactone polyol may be a compound obtained by the ring-opening polymerization of 8-caprolactone. The number average molecular weight of the polycaprolactone polyol may be between about 400-2,000 g/mol, or between about 500-1,500 g/mol, or between about 600-1,200 g/mol.

In one embodiment, the diisocyanate compound (A2) may be an aliphatic diisocyanate compound, alicyclic diisocyanate compound, aromatic diisocyanate compound and mixtures thereof. Out of these, aliphatic diisocyanate compounds and/or alicyclic diisocyanate compounds may be preferably used in some embodiments with the aliphatic diisocyanate compound accounting for about 30% by weight to about 100% by weight, or about 50% by weight to about 100% by weight of the total weight of component (A2).

Examples of the diisocyanate compound include, but are not limited to: aliphatic diisocyanate compounds, such as tetramethylene-1,4-diisocyanate, hexamethylene-1,6-diisocyanate, octamethylene-1,8-diisocyanate and 2,2,4-trimethylhexane-1,6-diisocyanate; alicyclic diisocyanate compounds, such as cyclobutane-1,3-diisocyanate, cyclohexane-1,3-diisocyanate, cyclohexane-1,4-diisocyanate, 2,4-methylcyclohexyl diisocyanate, 2,6-methylcyclohexyl diisocyanate, isophorone diisocyanate, norbornene diisocyanate, isomer mixtures of 4,4′-methylenebis(cyclohexyl isocyanate), hexahydrotoluene-2,4-diisocyanate, hexahydrotoluene-2,6-diisocyanate, hexahydrophenylene-1,3-diisocyanate, hexahydrophenylene-1,4-diisocyanate, 1,9-diisocyanato-5-methylnonane, 1,1-bis(isocyanatomethyl) cyclohexane, 2-isocyanato-4-[(4-isocyanatocyclohexyl)methyl]-1-methylcyclohexane, 2-(3-isocyanatopropyl)cyclohexyl isocyanate and norbornane diisocyanate; and aromatic diisocyanate compounds such as phenyl cyclohexylmethane diisocyanate, isomer mixtures of 4,4′-methylenebis(phenyl isocyanate), toluene-2,3-diisocyanate, toluene-2,4-diisocyanate, toluene-2,6-diisocyanate, phenylene-1,3-diisocyanate, phenylene-1,4-diisocyanate, 1,3-bis(isocyanatomethyl)benzene, xylylene diisocyanate, tetramethyl xylylene diisocyanate, naphthalene diisocyanate, diphenyl ether diisocyanate, 1,3-diisocyanatomethyl benzene, 4,4′-diisocyanato-3,3′-dimethoxy (1,1-biphenyl), 4,4′-diisocyanato-3,3′-dimethylbiphenyl, 1,2-diisocyanatobenzene, 1,4-bis(isocyanatomethyl)-2,3,5,6-tetrachlorobenzene, 2-dodecyl-1,3-diisocyanatobenzene, 1-isocyanato-4-[(2-isocyanatocyclohexyl)methyl]2-methylbenzene, 1-isocyanato-3-[(4-isocyanatophenyl)methyl]-2-methylbenzene, 4-[(2-isocyanatophenyl)oxy]phenyl isocyanate and diphenylmethane diisocyanate. These compounds may be used alone or in a combination of two or more.

In one embodiment, the diisocyanate compound includes tetramethylene-1,4-diisocyanate, hexamethylene-1,6-diisocyanate, octamethylene-1,8-diisocyanate, 2,2,4-trimethylhexane-1,6-diisocyanate, cyclobutane-1,3-diisocyanate, cyclohexane-1,3-diisocyanate, cyclohexane-1,4-diisocyanate, 2,4-methylcyclohexyl diisocyanate, 2,6-methylcyclohexyl diisocyanate, isophorone diisocyanate, norbornane diisocyanate, isomer mixtures of 4,4′-methylenebis(cyclohexyl isocyanate), hexahydrotoluene-2,4-diisocyanate, hexahydrotoluene-2,6-diisocyanate, hexahydrophenylene-1,3-diisocyanate, hexahydrophenylene-1,4-diisocyanate and mixtures thereof.

The polyamine compound having at least two amino groups in the molecule (B) may be a polyamine compound having at least two amino groups —NH₂ or —NH(R) where R is an alkyl group, such as an alkyl group having 1 to 5 carbon atoms in the molecule. In some embodiments, the molecular weight of the polyamine compound having at least two amino groups is between about 50 g/mol to about 300 g/mol, or between about 50 g/mol to about 250 g/mol, or between about 100 g/mol to about 220 g/mol.

Examples of the above polyamine compound (B) include, but are not limited to, isophorone diamine, ethylene diamine, 1,2-diaminopropane, 1,3-diaminopropane, 1,2-diaminobutane, 1,3-diaminobutane, 1,4-diaminobutane, 1,5-diaminopentane, 1,6-diaminohexane, piperazine, N,N-bis-(2-aminoethyl) piperazine, bis-(4-aminocyclohexyl) methane, bis-(4-amino-3-butylcyclohexyl) methane, 1,2-, 1,3- and 1,4-diaminocyclohexanes, norbornane diamine, hydrazine, dihydrazine adipate, phenylenediamine, 4,4′-diphenylmethane diamine, N,N′-diethylethylene diamine, N,N′-dimethylethylene diamine, N,N′-dipropylethylene diamine, N,N′-dibutylethylene diamine, N-methylethylene diamine, N-ethylethylene diamine, bis(hexamethylene)triamine, 1,2,5-pentanetriamine and mixtures thereof.

In order to synthesize the above polyurethane/polyurea resin, a compound having one group capable of reacting with an isocyanate group in the molecule (C) is also used. By using such a compound (C), a polyurethane/polyurea resin having a capped end of the molecular chain may be obtained. Examples of the one group capable of reacting with an isocyanate group include an amino group, a hydroxyl group, a mercapto group, a carboxyl group and an acid chloride group.

In one particular embodiment, the compound having one group capable of reacting with an isocyanate group in the molecule is a compound having the formula (1)

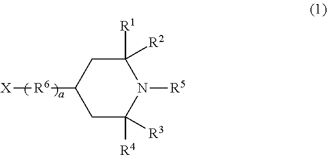

where R¹, R², R³ and R⁴ are each independently an alkyl group having 1 to 4 carbon atoms, R⁵ is an alkyl group having 1 to 10 carbon atoms or hydrogen, R⁶ is an alkylene group having 1 to 20 carbon atoms or a polymethylene group having 3 to 20 carbon atoms, a is 0 or 1, and X is a group capable of reacting with an isocyanate group, such as an amino group or a hydroxy group. Since R¹ to R⁴ are alkyl groups having 1 to 4 carbon atoms, even when R⁵ is hydrogen, the nitrogen atom bonded to R⁵ does not react with an isocyanate group due to the influence of steric hinderance. Examples of the compound represented by the above formula (1) include 1,2,2,6,6-pentamethyl-4-hydroxypiperidine, 1,2,2,6,6-pentamethyl-4-aminopiperidine, 2,2,6,6-tetramethyl-4-hydroxypiperidine, 2,2,6,6-tetramethyl-4-aminopiperidine, 1,2,2,6,6-pentamethyl-4-aminomethylpiperidine and 1,2,2,6,6-pentamethyl-4-aminobutylpiperidine.

Besides the above compound having the formula (1), ordinary amines, alcohols, thiols and carboxylic acids may also be used as the compound having one group capable of reacting with an isocyanate group in the molecule. For example, the compound having one group capable of reacting with an isocyanate group in the molecule may be a compound having a formula (2)

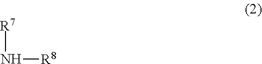

where R⁷ is an alkyl group having 1 to 20 carbon atoms, an aryl group, an aralkyl group, an alkyloxycarbonyl group or hydrogen and R⁸ is an alkyl group having 1 to 20 carbon atoms, an aryl group, an aralkyl group or an ester group.

In one embodiment, R⁷ is a methyl group, ethyl group, n-propyl group, isopropyl group, normal butyl group, tert-butyl group, pentyl group, hexyl group, heptyl group, octyl group, 1,1,3,3-tetramethylbutyl group, phenyl group, benzyl group, 1,1-dimethylbenzyl group, carboxymethyl group, carboxyethyl group, carboxypropyl group or hydrogen. In other embodiments, R⁸ is a methyl group, ethyl group, n-propyl group, isopropyl group, normal butyl group, tert-butyl group, pentyl group, hexyl group, heptyl group, octyl group, 1,1,3,3-tetramethylbutyl group, phenyl group, benzyl group, 1,1-dimethylbenzyl group, carboxymethyl group, carboxyethyl group or carboxypropyl group.

In another embodiment, the compound having one group capable of reacting with an isocyanate group in the molecule is a compound having the formula Z—R⁹ where R⁹ is an alkyl group having 1 to 20 carbon atoms, an aryl group, an aralkyl group or an alkyloxycarbonyl group, and Z is a hydroxyl group, a carboxyl group or a thiol group. In some embodiments, R⁹ is a methyl group, ethyl group, normal propyl group, isopropyl group, normal butyl group, tert-butyl group, pentyl group, hexyl group, heptyl group, octyl group, 1,1,3,3-tetramethylbutyl group, phenyl group, benzyl group, 1,1-dimethylbenzyl group, carboxymethyl group, carboxyethyl group or carboxypropyl group.

Examples of the above compound (C) (i.e. a compound having one group capable of reacting with an isocyanate group in the molecule) include: amines, such as methylamine, ethylamine, propylamine, isopropylamine, butylamine, tert-butylamine, pentylamine, hexylamine, heptylamine, 4-heptylamine, octylamine, 1,1-dipropylbutylamine, phenylamine, benzylamine, dimethylamine, diethylamine, dipropylamine, diisopropylamine, dibutylamine, di-tert-butylamine, dipentylamine, dihexylamine, diheptylamine, dioctylamine, methylethylamine, methylbutylamine, methylpentylamine, methylhexylamine, methylheptylamine, methyloctylamine, ethylpropylamine, ethylbutylamine, ethylpentylamine, ethylhexylamine, ethylheptylamine, ethyloctylamine, propylbutylamine, isopropylbutylamine, propylpentylamine, propylhexylamine, propylheptylamine and propyloctylamine; alcohols such as methanol, ethanol, propanol, isopropanol, butanol, 2-butanol, tert-butyl alcohol, pentyl alcohol, hexyl alcohol, heptyl alcohol, octyl alcohol, nonyl alcohol, decanol and 2-decanol; thiols such as methanethiol, ethanethiol, 1-propanethiol, 2-propanethiol, 1-butanethiol, 2-butanethiol, propanethiol, hexanethiol, heptanethiol, octanethiol, dodecanethiol, 2-methyl-1-butanethiol, 2-methylpropanethiol, 3-methyl-2-butenethiol, 1,1-dimethylheptanethiol, cyclohexanethiol, cyclopentanethiol, benzenethiol, benzene methanethiol and 2,6-dimethylbenzenethiol; and carboxylic acids such as acetic acid, propionic acid, butyric acid, pentanoic acid, hexanoic acid, heptanoic acid, octanoic acid, nonanoic acid, decanoic acid and dodecanoic acid. Such compounds may be used alone or in combination of two or more.

The polyurethane/polyurea resin may be obtained by any methods known to those skilled in the art, such as by reacting the components noted above, optionally in the presence of an organic solvent, in an inert atmosphere at temperatures ranging between −10° C. to 40° C. for a period of time, such as from 0.5 hours to 24 hours.

In some embodiments, the amount of the polyurethane/polyurea resin present in the composition may be an amount between about 10 wt. % to about 90 wt. %, or between about 20 wt. % to about 75 wt. %, or between about 30 wt. % to about 60 wt. %, or between about 40 wt. % to about 50 wt. %, based on the total weight of the composition. In another embodiment, the amount of the polyurethane/polyurea resin present in the composition may be an amount between about 50 wt. % to about 95 wt. %, or between about 65 wt. % to about 90 wt. %, based on the total weight of the composition.

In another embodiment, the curing agent is any chemical material(s) capable of curing the curable resin. Curing agents for the curable resin include, but are not limited to, aromatic amines, cyclic amines, aliphatic amines, alkyl amines, polyether amines, including those polyether amines that can be derived from polypropylene oxide and/or polyethylene oxide, 9,9-bis(4-amino-3-chlorophenyl) fluorene (CAF), acid anhydrides, carboxylic acid amides, polyamides, polyphenols, cresol and phenol novolac resins, imidazoles, guanidines, substituted guanidines, substituted ureas, melamine resins, guanamine derivatives, tertiary amines, Lewis acid complexes, such as boron trifluoride and boron trichloride and polymercaptans. Any epoxy-modified amine products, Mannich modified products, and Michael modified addition products of the exemplified curing agents listed above may also be used. All of the above-mentioned curing agents may be used either alone or in any combination.

Exemplary aromatic amines include, but are not limited to 1,8 diaminonaphthalene, m-phenylenediamine, diethylene toluene diamine, diaminodiphenylsulfone, diaminodiphenylmethane, diaminodiethyldimethyl diphenylmethane, 4,4′-methylenebis(2,6-diethylaniline), 4,4′-methylenebis(2-isopropyl-6-methylaniline), 4,4′-methylenebis(2,6-diisopropylaniline), 4,4′-[1,4-phenylenebis(1-methyl-ethylindene)]bisaniline, 4,4′-[1,3-phenylenebis(1-methyl-ethylindene)]bisaniline, 1,3-bis(3-aminophenoxy)benzene, bis-[4-(3-aminophenoxy)phenyl]sulfone, bis-[4-(4-aminophenoxy)phenyl]sulfone, 2,2′-bis[4-(4-aminophenoxy)phenyl]propane and bis(4-amino-2-chloro-3,5-diethylphenyl) methane. Furthermore, the aromatic amines may include heterocyclic multifunctional amine adducts as disclosed in U.S. Pat. Nos. 4,427,802 and 4,599,413, which are both hereby incorporated by way of reference in their entirety.

Examples of cyclic amines include, but are not limited to bis(4-amino-3-methyldicyclohexyl) methane, diaminodicyclohexylmethane, bis(aminomethyl)cyclohexane, N-aminoethylpyrazine, 3,9-bis(3-aminopropyl)-2,4,8,10-tetraoxaspiro (5,5) undecane, m-xylenediamine, isophoronediamine, menthenediamine, 1,4-bis(2-amino-2-methylpropyl) piperazine, N,N′-dimethylpiperazine, pyridine, picoline, 1,8-diazabicyclo[5,4,0]-7-undecene, benzylmethylamine, 2-(dimethylaminomethyl)-phenol, 2-methylimidazole, 2-phenylimidazole, and 2-ethyl-4-methylimidazole.

Exemplary aliphatic amines include, but are not limited to diethylenetriamine, triethylenetetramine, tetraethylenepentamine, 3-(dimethylamino) propylamine, 3-(diethylamino)-propylamine, 3-(methylamino) propylamine, tris(2-aminoethyl)amine; 3-(2-ethylhexyloxy) propylamine, 3-ethoxypropylamine, 3-methoxypropylamine, 3-(dibutylamino) propylamine, and tetramethyl-ethylenediamine; ethylenediamine; 3,3′-iminobis(propylamine), N-methyl-3,3′-iminobis(propylamine); allylamine, diallylamine, triallylamine, polyoxypropylenediamine, and polyoxypropylenetriamine.

Exemplary alkyl amines include, but are not limited to methylamine, ethylamine, propylamine, isopropylamine, butylamine, sec-butylamine, t-butylamine, n-octylamine, 2-ethylhexylamine, dimethylamine, diethylamine, dipropylamine, diisopropylamine, dibutylamine, di-sec-butylamine, di-t-butylamine, di-n-octylamine and di-2-ethylhexylamine.

Exemplary acid anhydrides include, but are not limited to, cyclohexane-1,2-dicarboxylic acid anhydride, 1-cyclohexene-1,2-dicarboxylic acid anhydride, 2-cyclohexene-1,2-dicarboxylic acid anhydride, 3-cyclohexene-1,2-dicarboxylic acid anhydride, 4-cyclohexene-1,2-dicarboxylic acid anhydride, 1-methyl-2-cyclohexene-1,2-dicarboxylic acid anhydride, 1-methyl-4-cyclohexene-1,2-dicarboxylic acid anhydride, 3-methyl-4-cyclohexene-1,2-dicarboxylic acid anhydride, 4-methyl-4-cyclohexene-1,2-dicarboxylic acid anhydride, dodecenylsuccinic anhydride, succinic anhydride, 4-methyl-1-cyclohexene-1,2-dicarboxylic acid anhydride, phthalic anhydride, hexahydrophthalic anhydride, nadic methyl anhydride, dodecenylsuccinic anhydride, tetrahydrophthalic anhydride, maleic anhydride, pyromellitic dianhydride, trimellitic anhydride, benzophenonetetracarboxylic dianhydride, bicyclo[2.2.1]hept-5-ene-2,3-dicarboxylic anhydride, methylbicyclo[2.2.1]hept-5-ene-2,3-dicarboxylic anhydride, bicyclo[2.2.1]hept-5-ene-2,3-dicarboxylic anhydride, dichloromaleic anhydride, chlorendic anhydride, tetrachlorophthalic anhydride and any derivative or adduct thereof.

Exemplary imidazoles include, but are not limited to, imidazole, 1-methylimidazole, 2-methylimidazole, 2-ethylimidazole, 2-isopropylimidazole, 2-n-propylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-isopropyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 2-phenyl-4-methyl-5-hydroxymethylimidazole, 2-phenylimidazole, 2-phenyl-4,5-dihydroxymethylimidazole, 1,2-phenyl-4-methyl-5-hydroxymethylimidazole, 1-dodecyl-2-methylimidazole and 1-cyanoethyl-2-phenyl-4,5-di(2-cyanoethoxy)methylimidazole.

Exemplary substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and cyanoguanidine (dicyandiamide). Representatives of guanamine derivatives which may be mentioned are alkylated benzoguanamine resins, benzoguanamine resins or methoxymethylethoxymethylbenzoguanamine. Substituted ureas may include p-chlorophenyl-N, N-dimethylurea (monuron), 3-phenyl-1,1-dimethylurea (fenuron) or 3, 4-dichlorophenyl-N,N-dimethylurea (diuron).

Exemplary tertiary amines include, but are not limited to, trimethylamine, tripropylamine, triisopropylamine, tributylamine, tri-sec-butylamine, tri-t-butylamine, tri-n-octylamine, N,N-dimethylaniline, N,N-dimethyl-benzylamine, pyridine, N-methylpiperidine, N-methylmorpholine, N,N-dimethylaminopyridine, derivatives of morpholine such as bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, and tris(2-(4-morpholino) propyl)amine, diazabicyclooctane (DABCO), and heterocyclic compounds having an amidine bonding such as diazabicyclono.

In one embodiment, the curing agent is a multifunctional amine. The term “multifunctional amine” as used herein refers to an amine having at least two primary and/or secondary amino groups in a molecule. For example, the multifunctional amine may be an aromatic multifunctional amine having two amino groups bonded to benzene at any one of ortho, meta and para positional relations, such as phenylenediamine, xylenediamine, 1,3,5-triaminobenzene, 1,2,4-triaminobenzene and 3,5-diaminobenzoic acid, an aliphatic multifunctional amine such as ethylenediamine and propylenediamine, an alicyclic multifunctional amine such as 1,2-diaminocyclohexane, 1,4-diaminocyclohexane, piperazine, 1,3-bispiperidylpropane and 4-aminomethylpiperazine, and the like. These multifunctional amines may be used alone or in a mixture.

Amine-epoxy adducts may also be used and are well-known in the art and are described, for example, in U.S. Pat. Nos. 3,756,984, 4,066,625, 4,268,656, 4,360,649, 4,542,202, 4,546,155, 5,134,239, 5,407,978, 5,543,486, 5,548,058, 5,430,112, 5,464,910, 5,439,977, 5,717,011, 5,733,954, 5,789,498, 5,798,399 and 5,801,218, each of which is incorporated herein by reference in its entirety. Such amine-epoxy adducts are the products of the reaction to a predetermined degree of polymerization between one or more amine compounds and one or more epoxy compounds. Preferably, the adduct is a solid which is insoluble in the epoxy resin at room temperature, but which becomes soluble and functions as an accelerator to increase the cure rate upon heating. While any type of amine can be used (with heterocyclic amines and/or amines containing at least one secondary nitrogen atom being preferred), imidazole compounds are particularly preferred. Illustrative imidazoles include 2-methyl imidazole, 2,4-dimethyl imidazole, 2-ethyl-4-methyl imidazole, 2-phenyl imidazole and the like. Other suitable amines include, but are not limited to, piperazines, piperidines, pyrazoles, purines, and triazoles. Any kind of epoxy compound can be employed as the other starting material for the adduct, including monofunctional, and multi-functional epoxy compounds such as those described previously with regard to the epoxy resin component.

In one embodiment, the composition of the present disclosure may contain the curing agent in an amount of between about 10 wt. % to about 60 wt. %, or between about 20 wt. % to about 50 wt. %, or between about 30 wt. % to about 50 wt. %, based on the total weight of the composition. In another embodiment, the composition of the present disclosure may contain the curing agent in an amount of between about 5 wt. % to about 50 wt. %, or between about 10 wt. % to about 45 wt. %, or between about 20 wt. % to about 40 wt. %, based on the total weight of the composition.

The composition also includes a surface modifying agent. In one embodiment, the surface modifying agent includes a reactive siloxane. The reactive siloxane includes any polymer, co-polymer or oligomer that includes siloxane units in the backbone having a formula

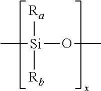

where Rₐ and R_{b} are independently of one another, hydrogen, alkyl, cycloalkyl, alkenyl, acyl, aryl, alkaryl or aralkyl having up to 100 carbon atoms, or up to 20 carbon atoms, x is the number of siloxane monomer units in the siloxane polymer and where the siloxane polymer includes at least one reactive group on at least a portion of the siloxane monomer units that is capable of reacting chemically with another reactive group on a different substance, for example, the curing agent and/or preferably the curable resin to form a covalent or ionic linkage reactive functionality. The backbone of the siloxane polymer can include alkyl substitutions and phenyl substitutions. In some embodiments, the reactive group on at least a portion of the siloxane monomer units may be an amino group, an epoxy group, a hydroxyl group, an anhydride group, an acrylate group, a perfluoro group or a mixture thereof.

In one embodiment, the reactive siloxane is a compound having the formula (3) or (4)

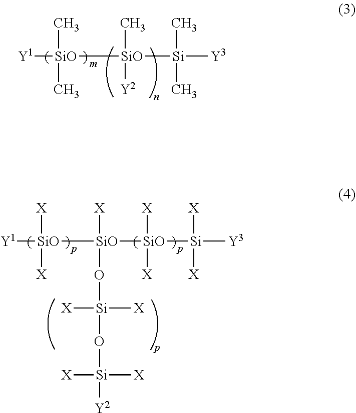

where each X is independently an alkyl, aryl or cycloalkyl group, each of Y¹, Y² and Y³ is independently X or a reactive group such as an amino group, an epoxy group, an anhydride group, an acrylate group or a perfluoro group provided that at least one of Y¹, Y² or Y³ is not X, m is a number from about 1 to about 10000, n is a number from 0 to about 10, and each p is independently a number from 0 to about 1000 provided that at least one p is at least about 10. When Y¹ and/or Y³ is a reactive group and Y² is X in formula (3), the reactive siloxane is a reactive group-terminated siloxane. It is to be understood that the internal reactive groups Y² may be distributed randomly within the polysiloxane chain, and the representation of the siloxane in the above formulas should not be interpreted as requiring that all of the SiO groups having a functional group Y² are attached in sequence in a block.

In some embodiments, each X is independently an alkyl group, an aryl group, a cycloalkyl group or an alkaryl group having up to 20 carbon atoms. Examples of X groups include methyl, ethyl, propyl, butyl, isopropyl, hexyl, dodecyl, octadecyl, 2-phenylpropyl, cyclopentyl, cyclohexyl, cyclooctyl, phenyl, benzyl, styryl, tolyl and xylyl groups.

Values of m, n and p in formulae (3) and (4) may be varied to provide polysiloxanes having any desirable molecular weight, such as from about 800 to about 20,000 Daltons. The value of n also may be varied to provide reactive siloxanes having an increased or decreased reactive group content.

In an embodiment, the reactive siloxane is a compound having formula (3) or (4), where each X is a methyl group and each Y¹, Y² and Y³ is independently an alkyl group or a reactive group comprising an amino group, an epoxy group, a hydroxyl group, an anhydride group, an acrylate group or a perfluoro group, m is a number from about 1 to about 10000, n is a number from 0 to about 10, each p is independently a number from 0 to about 1000 provided that at least one p is at least 10 and further provided at least one Y¹, Y² and Y³ is not an alkyl group. Again, it is to be understood that the internal reactive groups Y² may be distributed randomly within the polysiloxane chain, and the representation of the siloxane in the above formulas should not be interpreted as requiring that all of the SiO groups having a functional group Y² are attached in sequence in a block.

In one embodiment, the reactive group is an amino group having a formula —R′N(R_{c})₂ where R′ is a divalent group consisting of carbon and hydrogen and optionally oxygen or nitrogen and which may further be an aliphatic group or a cycloaliphatic group and each R_{c} is independently hydrogen or an alkyl group having 1 to 8 carbon atoms or an aryl group having 6 to 8 carbon atoms. Accordingly, R′ may be an alkylene group, a cycloalkylene group, oxyalkylene or oxycycloalkylene group, or an amino alkylene or amino cycloalkylene group attached to the silicon atom. Specific examples of R′include —CH₂—, —CH₂CH₂—, —CH₂—CH₂—CH₂—, -cyclohexylene, —OCH₂CH₂—, —OCH₂CH₂CH₂—, —NCH₂CH₂—, —CH₂CH₂CH₂N(H)CH₂—CH₂—. In one embodiment, R′ is a divalent group containing from 1 to about 3 carbon atoms. The amino group also includes the above-identified amines and salts thereof including quaternary salts which may be obtained by techniques known to those skilled in the art. Specific examples of amino groups which may be present on the reactive siloxanes include —CH₂NH₂, —CH₂N(H)CH₃, —CH₂N(H)C₆H₁₁, —CH₂CH₂CH₂NH₂, —CH₂CH₂CH₂N(CH₃)₂, -cyclohexylamine, —OCH(CH₃)CH₂NH₂, —OCH(CH₃)CH₂CH₂NH₂, —C₃H₆N(H)C₂H₄NH₂, and —CH₂CH₂CH₂N⁺(CH₃)HCH₃—COO⁻.

In another embodiment, the reactive group is an epoxy group having the formula

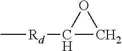

where R_{d} is an alkyl group having 1 to 10 carbon atoms, a cycloalkyl group having 5 to 20 carbon atoms, an aryl group having 6 to 9 carbon atoms, a direct bond or an alkyl-O-alkyl group having 3 to 10 carbon atoms. In another embodiment, the reactive group is an epoxy group having the formula

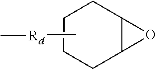

where R_{d} is an alkyl group having 1 to 4 carbon atoms.

In yet another embodiment, the reactive group is an acrylate group having the formula —CH₂CH₂C(O)—ORₑ—[O—C(O)CH═CH₂]ₙ₋₁ where n is a number from 2 to about 50 and Re is an alkyl group having 1 to 20 carbon atoms or an aryl group having 6 to 10 carbon atoms.

In still another embodiment, the reactive group is a hydroxyl group having the formula —R_{f}OH where R_{f} is an alkyl group having 1 to about 20 carbon atoms or a direct bond.

In another embodiment, the reactive group is an anhydride group having a formula

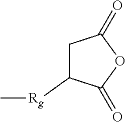

where R_{g} is an alkyl group having 1 to 10 carbon atoms.

In another embodiment, the surface modifying agent is a reactive fluoro compound. The reactive fluoro compound may be a fluorine-containing monomer or oligomer with polymerizability and it may have 1 to 10 reactive groups, for example, those selected from (meth)acrylate, imide, amide, vinyl, urethane, ester, epoxy, and alcohol.

In one particular embodiment, the reactive fluorine may have a formula R¹⁰—CF₃ where R₁₀ is CH₂═CR₁₁COOR₁₂— where R¹¹ is hydrogen or an alkyl group having 1 to 3 carbon atoms and R¹² is an alkyl group having 1 to 6 carbon atoms, such as a methyl group, an ethyl group, a trimethyl group, a methylethyl group, a propyl group, a tetramethyl group, a pentamethyl group, and a hexamethyl group.

In another embodiment, the reactive fluoro compound is a compound having a formula R¹³—R^{f}—R¹³ where R¹³ is CH₂═CR₁₄COO— where R¹⁴ is hydrogen or an alkyl group having 1 to 3 carbon atoms and R^{f} is a compound selected from the group of (a) to (e)

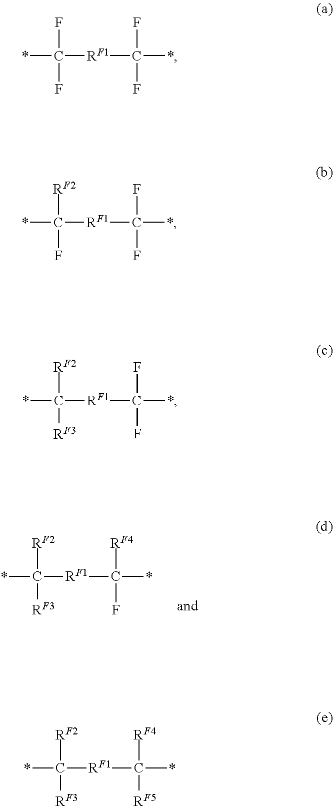

where * is a bonding site to R₁₃, R^{F1} is a perfluoroalkyl group having 1 to 14 carbon atoms and R^{F2}, R^{F3}, R^{F4}, and R^{F5} are each independently hydrogen or a perfluoroalkyl group having 1 to 14 carbon atoms.

Specific examples of the reactive fluoro compound may include 6-perfluorohexanol, 3-perfluorobutylpropanol, 2-perfluoropropyltetrafluoropropanol, 2,5-ditrifluoromethyldioxaundecafluorononanol, octafluorohexanediol, perfluorobutylepoxypropane, perfluoromethylbutylepoxypropane, tetrafluoropropoxyepoxypropane, 1,4-bisepoxypropylperfluoro-n-butane, perfluorohexylethylene, 1-methoxyperfluoromethylpropane, 1,4-divinyldodecafluorohexane, 3-perfluorobutylhydroxypropylmethacrylate, 3-trifluoroethylmethacrylate, perfluorohexylhydroxylpropylmethacrylate, tetrafluoropropylmethacrylate, 2-perfluorohexylethylacrylate, 3-perfluoromethylbutyl-2-hydroxypropylacrylate, methyltrifluoroacetate, ethyltrifluoroacetate, trifluoroethylmethylether, tetrafluoroethylmethylether, hectafluorobutylamine, tridecafluoroheptylamine, and derivatives thereof.

The composition of the present disclosure may contain the surface modifying agent in an amount of between about 0.01 wt. % to about 8.0 wt. %, or 0.01 wt. % to about 3.0 wt. %, or between about 0.02 wt. % to about 2.0 wt. %, or between about 0.03 wt. % to about 1.0 wt. %, or preferably between about 0.05 wt. % to about 0.5 wt. %, based on the total weight of the composition [for wt. % the original weight fractions must be multiplied by 100]. In another embodiment, the composition of the present disclosure may contain the surface modifying agent in an amount of between about 0.01 wt. % to about 1.0 wt. %, or between about 0.03 wt. % to about 0.5 wt. %, or between about 0.05 wt. % to about 0.3 wt. %, based on the total weight of the composition.

According to one embodiment, the curable resin comprises (i) an epoxy resin, for example, a difunctional epoxy resin, a trifunctional meta-glycidyl amine and/or N,N,N′,N′-tetraglycidyl methylene dianiline (ii) a curing agent, for example an aromatic amine, a cyclic amine and/or a polyetheramine and (iii) a surface modifying agent, for example, a reactive siloxane such as an amine-terminated or epoxy-terminated polysiloxane.

In another embodiment, the composition may also contain one or more other additives which are useful for their intended uses. For example, the optional additives which are useful may include, but are not limited to, diluents, stabilizers, surfactants, flow modifiers, release agents, matting agents, degassing agents, toughening agents (for e.g. a core shell rubber, a liquid rubber or functionalized rubber such as carboxyl terminated liquid butadiene acrylonitrile rubber, amine terminated liquid butadiene acrylonitrile rubber, hydroxyl terminated liquid butadiene acrylonitrile rubber, acrylic terminated liquid butadiene acrylonitrile rubber, epoxy terminated liquid butadiene acrylonitrile rubber, hydroxyl terminated liquid butadiene acrylonitrile rubber, and liquid epoxy resin (LER) adducts of elastomers), curing inhibitors, wetting agents, processing aids, fluorescent compounds, UV stabilizers, antioxidants, impact modifiers, corrosion inhibitors, tackifiers, rheology modifying agents (for e.g. fumed silica, colloidal silica, hydroxyethyl cellulose, hydroxypropyl cellulose, fly ash (as defined in ASTM C618), polyoxyalkylenes, polysaccharides, natural gums, various naturally occurring clays, such as kaolin, bentonite, montmorillonite or modified montmorillonite, attapulgate and Buckminsterfuller's earth; other naturally occurring or naturally derived materials, such as mica, calcium carbonate and aluminum carbonate; various oxides, such as ferric oxide, titanium dioxide, calcium oxide and silicon dioxide (for e.g., sand); various man-made materials, such as precipitated calcium carbonate; and various waste materials such as crushed blast furnace slag), conducting particles (for e.g. silver, gold, copper, nickel, aluminum and conducting grades of carbon and carbon nanotubes) and mixtures thereof.

When present, the amount of additives included in the composition may be in an amount of at least about 0.1 wt. %, or at least 0.5 wt. %, or at least 2 wt. %, or at least 5 wt. % or at least 10 wt. %, based on the total weight of the composition. In other embodiments, the amount of additives included in the composition may be no more than about 30 wt. %, or no more than 25 wt. %, or no more than 20 wt. % or no more than 15 wt. %, based on the total weight of the composition.

The composition may be prepared for example, by premixing individual components and then mixing these premixes, or by mixing all of the components together using customary devices, such as a stirred vessel, stirring rod, ball mill, roll mill, sample mixer, static mixer, high shear mixer, screw extruder, ribbon blender or by hot melting.

Thus, according to another embodiment, the composition of the present disclosure may be prepared by mixing together from about 10 wt. % to about 90 wt. % of the curable resin and from about 0.0001 wt. % to about 0.3 wt. % of the surface modifying agent and from about 10 wt. % to about 60 wt. % of the curing agent, where the wt. % is based on the total weight of the composition.

The composition of the present disclosure is preferably a one-pack curable composition in the viewpoint of handling and in some embodiments can be used as a structural adhesive for vehicle and aerospace structures, an adhesive for wind power-generating structures, a paint, a laminate material using glass fiber, a material for printed wiring substrates, a solder resist, an interlayer insulating film, a build-up material, an adhesive for FPCs, an electrically insulating material including a sealing material for electronic components such as semiconductors and LEDs, a die bonding material, an underfill, a semiconductor packaging material, a sealing material such as a sealing material for display devices and lighting devices including a liquid crystal panel, an OLED lighting devices and an OLED display.

In particular, the composition of the present disclosure is useful for bonding various automotive and aerospace structural materials to form a laminate structure, including metal to metal, metal to composite material, metal to ceramic, composite material to composite material, composite material to ceramic, and ceramic to ceramic.

The composite material may include a wide variety of thermoplastic resins commonly used in the but not limited industry, including, to, thermoplastic polyetherimides, polypropylene (PP), polypropalene, polyetherimide (PEI), polyphenylene sulfide (PPS), polyether ether ketone (PEEK), polyaryletherketone (PAEK), and polyetherketoneketones (PEKK).

The ceramic may include, but is not limited to, oxides, nitrides, and carbides of metals such as aluminum oxide, aluminum nitride, boron oxide, boron nitride, boron carbide, titanium oxide, titanium nitride, titanium carbide, silicon oxide, calcium oxide, magnesium oxide, silicon nitride, beryllium oxide, silicon carbide, mullite and borosilicate glass.

Composite materials include fiber-reinforced resin composites, such as prepregs or a prepreg layup used for making automotive and aircraft composite structures. The term “prepreg” as used herein refers to a sheet or lamina of fibers that has been impregnated with a matrix resin. The matrix resin may be present in an uncured or partially cored state. The term “prepreg layup” as used herein refers to a plurality of prepreg layers that are placed adjacent one another in a stack. The prepreg layers within the layup may be positioned in a selected orientation with respect to one another. For example, prepreg layups may comprise prepreg layers having unidirectional fiber architectures, with the fibers oriented at 0°, 90°, a selected angle θ, and combinations thereof, with respect to the largest dimension of the layup, such as the length. It should be further understood that, in certain embodiments, prepregs may have any combination of fiber architectures, such as unidirectional and multi-dimensional fiber structures. Fibers that are useful include carbon or graphite fibers, glass fibers and fibers formed of silicon carbide, alumina, boron, quartz, and the like, as well as fibers formed from organic polymers, such as for example polyolefins, poly(benzothiazole), poly(benzimidazole), polyarylates, poly(benzoxazole), aromatic polyamides, polyaryl ethers and the like, and may include mixtures having two or more such fibers.

After mixing the composition, a paste adhesive is formed that can be applied to a surface of the metal and/or composite material by conventional dispensing means known to those skilled in the art such as bead or film application onto one or more surfaces to be bonded. In an alternative embodiment, the paste adhesive may be processed into a film format by a conventional hot-melt coating process known to those skilled in the art. Examples of such a coating process include, but are not limited to, reverse roll-coating, slot-die coating, knife-over-roll coating, knife-over-plate coating, dip and squeeze coating, reverse gravure coating, micro gravure coating, comma roll coating, and forward gravure coating. For structural bonding of metals and composite materials, the adhesive may be applied at a thickness of 5 to 100 mils, or 5 to 80 mils (0.254 mm to 2.032 mm), preferably 8 to 20 mils. The surfaces are then brought together to form a laminate with an adhesive film in between the substrates. Subsequently, the resultant laminate may be cured at a temperature of about 80° C. or above, or about 140° C. or above or about 220° C. or less, or about 180° C. or less, with use of elevated pressure to restrain deforming effects of escaping gases, or to restrain void formation, at a pressure of up to 10 bar (1 MPa), preferably in the range of 2 bar (0.3 MPa) to 7 bar (0.7 MPa). In some embodiments, the cure temperature is attained by heating at up to 5° C./min, for example 2° C./min to 3° C./min and is maintained at the cure temperature for a period of up to 9 hours, or up to 6 hours, for example 2 hours to 4 hours. Pressure can be released throughout, and the temperature can be reduced by cooling at up to 5° C./min or less, preferably 3° C./min or less. Post-curing at temperatures in the range of about 190° C. up to about 350° C. and at atmospheric pressure may be performed, employing suitable heating rates.

Thus, the present disclosure also provides a method of bonding a first substrate to a second substrate including applying the composition of the present disclosure to a surface of at least one of the first substrate and the second substrate to form an adhesive film on the surface, contacting the first substrate and the second substrate such that the adhesive film is therebetween and curing the adhesive film to form an adhesive bond between the first and second substrates.

### Examples

### General Overview

Five different structural film adhesives were tested, including an aerospace-qualified structural film adhesive control (3M™ Scotch-Weld™ Structural Adhesive Film AF 191), and four structural adhesives according to the present disclosure HA-X1, HA-X2, HA-X3 and HA-X4 which are shown below in Table 1. Each was designed and developed to be tolerant to silicone contaminations at bonding surfaces. Mechanical performance of these structural adhesives on pristine (uncontaminated-U) and silicone-coated (contaminated-C) carbon fiber reinforced polymer (CFRP) adherends was then determined and the results are detailed further below.

| | | Sample ID | | | |
|---|---|---|---|---|---|
| | | HA-X1 | HA-X2 | HA-X3 | HA-X4 |
| # | Component | wt % | wt % | wt % | wt % |
| 1 | Tetrafunctional epoxy resin | 28.50 | 22.80 | 22.80 | 22.60 |
| 2 | Difunctional epoxy resin | 45.00 | 52.00 | 52.00 | 52.00 |
| 3 | Adduct of amine terminated | 0.30 | | | |
| | polysiloxane/epoxy resin | | | | |
| 4 | Amine-terminated | | 0.30 | 0.30 | 0.30 |
| | polysiloxane | | | | |
| 5 | Silane coupling agent | 0.50 | 0.60 | 0.50 | 0.50 |
| 6 | Cycloaliphatic amine | 1.70 | 1.50 | 1.30 | 1.00 |
| 7 | Aliphatic amine | 5.00 | 4.50 | 5.20 | 6.30 |
| 8 | Fumed silica | 0.50 | 0.50 | 0.30 | 0.30 |
| 9 | Aromatic amine | 18.50 | 18.00 | 17.60 | 17.00 |
| | Totals | 100.00 | 100.20 | 100.00 | 100.00 |

### Composite Panel Fabrication

The performance of the HA-X1 to HA-X4 adhesives to the control adhesive was determined using CFRP panels made from prepreg plies of HexPly® 8552 epoxy matrix (IM7/8552 prepreg plies). In particular, CFRP panels were made from HexPly® 8552 epoxy matrix according to the autoclave cure cycle provided in the product technical datasheet. Each panel was made from a stack of 19 plies of HexPly® 8552 epoxy matrix with carbon fibers (IM) oriented in 0° direction, i.e., [0°]₁₉. The stack was sandwiched between two HYSOL® EA 9895 wet peel ply's and bagged. The autoclave cure cycle of HexPly® 8552 epoxy matrix was as following (per the product datasheet): i) applying full vacuum and 15 psig pressure to the vacuum bag; ii) heating at 3-5° F./min to 225° F.; iii) holding isothermally at 225° F. for 30-60 minutes; iv) raising the pressure to 85-100 psig; v) venting vacuum when the pressure reached 30 psig; vi) holding isothermally at 350° F. for 120±10 minutes; vii) cooling at 2-5° F./min to 150° F. and venting the autoclave pressure.

### Surface Coating

To consistently and repeatably coat composite panels, a spray system equipped with digital controllers, stepper motors, linear actuators, and a digital syringe pump was built and used in this study. The parameters of the spray system were precisely controlled to deposit 30-40 μg/in² onto each composite panel. To adjust the deposition amount, the following parameters were accurately controlled: i) nozzle-to-substrate distance (in), ii) N₂ gas pressure at atomizer inlet (psi), iii) liquid flow rate (ml/min), iv) gas flow rate (standard cubic feet per minute, SCFM). To monitor the coating process, a witness coupon was used, and its weight was measured before and after coating to ensure a predetermined amount of contaminant had been deposited. The tolerance in the weight of deposited contaminant was approximately 10-15 μg/in². An aerospace-qualified mold-release agent, LOCTITE® FREKOTE 44NC™ agent, was used as the contaminating agent for the tests below.

### Fabrication of Testing Specimens

One layer of a film adhesive was sandwiched between two sub-panels which had been pretreated by one of the following surface treatments, (Surface Prep (SP)-1, or -2 with or without contamination):
i. Surface Prep #1, for Carbon-Epoxy (SP-1): Remove Peel Ply (wet)/Apply Spray Contamination (if applicable);
ii. Surface Prep #2, for Carbon-Epoxy (SP-2): Remove Peel Ply (wet)/Apply Spray Contamination (if applicable)/3M Scotch-Brite™ Abrade (30 seconds of light, even, Scotch-Brite™ sanding)/Acetone Solvent Wipe;

Stainless steel (SS) wires (diameter of 7 mil) were used to control the bond-line thickness. Each assembly was properly bagged and included quarter round, dam tape, and breather to build up areas that could cause bridging or risk perforating the vacuum bag, particularly fixture edges. Three thermocouples were used per caul plate, and attached directly to bonding fixtures, to ensure a good representation of the entire area. The assembly was treated in an autoclave with a cure cycle as following: i) applying a vacuum level in the range of 5-8 in Hg to the vacuum bag; ii) raising the autoclave pressure to 45 psi prior to heating, and venting the vacuum bag to atmospheric pressure when the autoclave pressure reached 10 psi; iii) heating the assembly to 350° F. with a heating ramp rate of 5° F./min and holding isothermally at 350° F. for 1 hour at an autoclave pressure of 45 psi. The single lap shear specimens were obtained by bonding two sub-panels of 4″×7″ with 1″ overlap along the length of the sub-panels, in accordance with the specification of ASTM D5868. Once cured, the bonded panels were machined using a diamond wet saw. Single lap shear specimens were 1″×7″ with a bonded overlap area of nearly 1.0 in². In addition, the Double Cantilever Beam (DCB) specimens were prepared by bonding sub-panels of 8″×14″. Bonded DCB panels were subsequently cut using a water-jet machine to form DCB specimens of 1″×14″, with a 2.5″ non-bonded area from one edge. For DCB specimens, a PTFE insert with a thickness of 0.5 mil was placed to generate a natural crack per the specification of ASTM D5528.

### Mechanical Performance

Testing included conventional single lap shear (per ASTM D1002/ASTM D5868) and Mode I fracture toughness (per ASTM D5528) conducted at room temperature ambient (RTA), sub-ambient temperature (LT) at −67° F., elevated temperature dry (ETD) at 180° F., and elevated temperature wet (ETW) 180° F. wet conditions.

### (a) Single Lap Shear

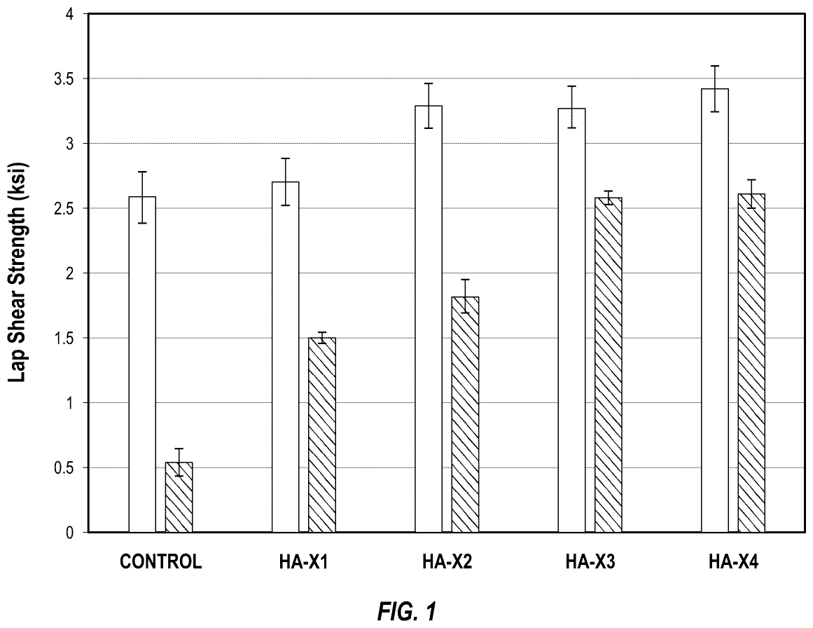

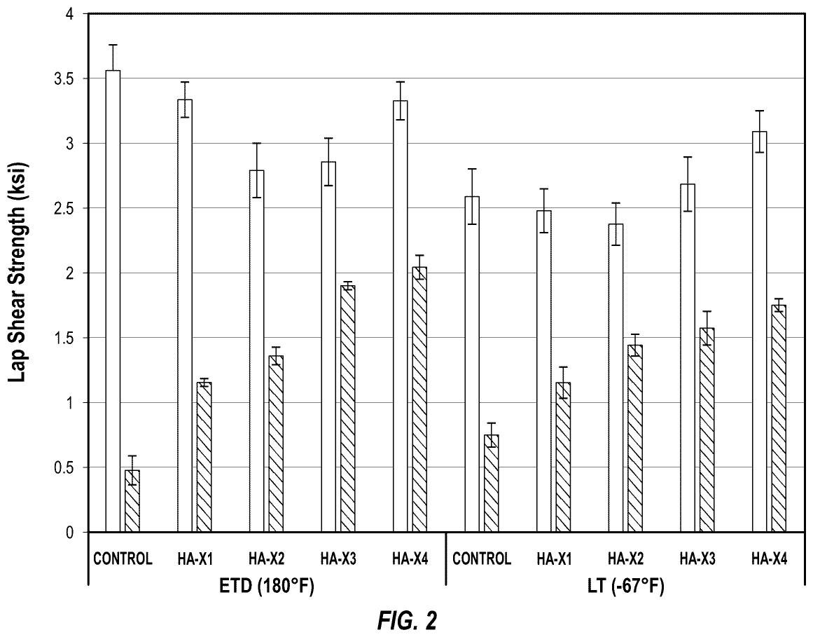

i) Lap shear strength-FIG. 1 shows the adhesive bond strength in shear mode in the adhesives according to the present disclosure (HA-X1 to HA-X4), as well as the control on both contaminated (SP-1/C) and uncontaminated (SP-1/U) composite adherends. All specimens were tested at room-temperature ambient (RTA) conditions. The solid bars in FIG. 1 represent strength values of corresponding adhesives with uncontaminated (SP-1/U) composite adherends, while the hatched bars represent strength values of corresponding adhesives with contaminated (SP-1/C) composite adherends. Each average and the corresponding errors were obtained from at least 6 replicates. The results demonstrate the significantly improved performance of the adhesives according to the present disclosure when compared with the control on both uncontaminated (SP-1/U), and more importantly, contaminated composite adherends (SP-1/C). In addition, the lap shear strength of adhesive joints with composite adherends was measured at elevated temperature dry (ETD), and low temperature (LT) in accordance with the specification of MMM-A-132B. FIG. 2(a) depicts the shear strength in single lap shear mode (according to ASTM D5868) for the adhesives (HA-X1 to HA-X4), as well as the control, with contaminated (hatched bars) and uncontaminated (solid bars) composite adherends at elevated temperature (ETD) and low temperature (LT). The results shown in FIG. 2 indicate that the mechanical performance of the adhesives according to the present disclosure on uncontaminated composite adherends was not adversely affected when tested at ETD (180° F.) and LT (−67° F.) conditions. It is also evident from the results that the adhesives according to the present disclosure outperformed the control adhesive in silicone-contaminated composite adherends at both ETD (180° F.) and LT (−67° F.).

ii) Strength retention-surface tolerant characteristics of each adhesive were further examined using a strength retention factor, which is defined as the ratio of shear strength of an adhesive at a silicone contaminated interface to the same quantity at a pristine interface. The strength retention was 21% for the control adhesive, whereas this value was found to be 56%, 55%, 79%, and 76%, for HA-X1 through HA-X4, respectively. The strength retention again clearly demonstrated the significantly improved silicone-tolerance characteristics of the adhesives according to the present disclosure as compared with the control adhesive.

### (B) Fracture Toughness

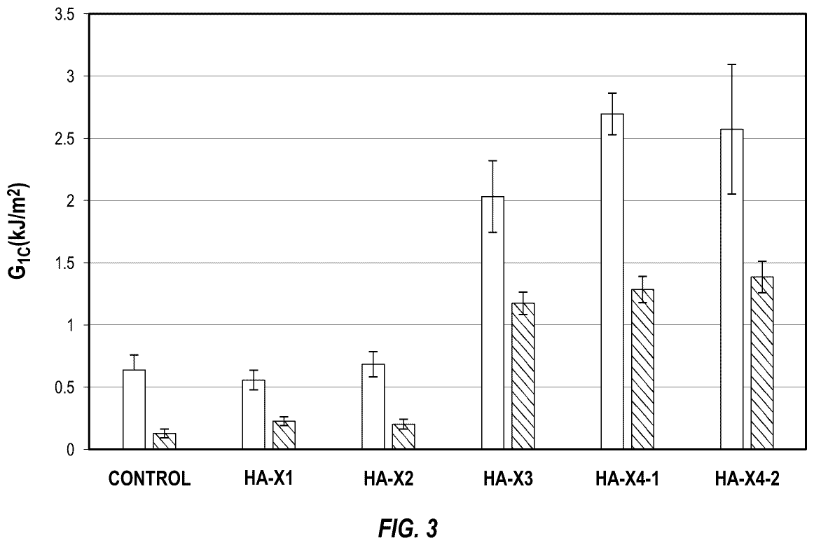

FIG. 3 depicts the Mode I fracture toughness Gic values of the adhesives (HA-X1 through HA-X4) as well as the control adhesive in contaminated (hatched bars) and uncontaminated (solid bars) C/C adherends. Each average and the corresponding errors were obtained from at least 6 replicates. When compared to the control adhesive, HA-X1 and HA-X2 revealed slightly higher resistance to fracture in the presence of silicone contamination, while the Gic values with pristine (uncontaminated) composite adherends were relatively similar. The further improved performance of HA-X3 and HA-X4 with uncontaminated and contaminated composite adherends is evident in FIG. 3. An additional batch of DCB specimens bonded with HA-X4 (HA-X4-2) were prepared and Gic values were measured with uncontaminated and contaminated composite adherends.

The results shown in FIG. 3 confirmed the reproducibility of Gic values for HA-X4.

### Adhesive Surface Energy and Polarity

The surface energy as well as polarity and dispersive components of the control and the adhesives according to the present disclosure (HA-X1 to HA-X4) were calculated based on the Wu's harmonic model (see Wu, Souheng, “Polymer Interface and Adhesion”, New York: Marcel Dekker, 1982), using advancing contact angles of DI water and Tricresyl phosphate (TCP) at room temperature. Additionally, these quantities were determined for an epoxy surface coated with the same solution of LOCTITE® FREKOTE 44NC™ agent. The calculated results are shown in Table 2 and indicate successful control of the surface polarity of the adhesives according to the present disclosure, particularly HA-X2 to HA-X4.

TABLE 2

| | Advancing Contact | | Surface Energy | | |
|---|---|---|---|---|---|
| | Angle (°) | | Components (mN/m) | | |
| Adhesive | DI water | TCP | γₛ | γₛ^{d} | γₛ^{p} |
| Cast epoxy coated | 106.1 ± 1.7 | 84.6 ± 1.4 | 18.9 | 13.9 | 5.0 |
| with LOCTITE ® | | | | | |
| FREKOTE | | | | | |
| 44NC ™ | | | | | |
| Control | 89.9 ± 1.15 | 40.6 ± 0.6 | 35.9 | 29.9 | 6.0 |
| HA-X1 | 89.5 ± 0.8 | 52.8 ± 0.8 | 32.6 | 25.2 | 7.4 |
| HA-X2 | 82.2 ± 0.7 | 41.75 ± 0.8 | 38.7 | 29.3 | 9.4 |
| HA-X3 | 80.7 ± 0.9 | 41.9 ± 1.0 | 39.3 | 29.2 | 10.1 |
| HA-X4 | 75.3 ± 1.3 | 41.0 ± 1.1 | 42.0 | 29.5 | 12.5 |

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

What is claimed is:

1. A composition comprising (a) a curable resin, (b) a curing agent, and (c) a surface modifying agent selected from the group consisting of a reactive siloxane, a reactive fluoro compound and a mixture thereof.

2. The composition of claim 1, wherein the curable resin is an epoxy resin.

3. The composition of claim 2, wherein the epoxy resin is selected from a difunctional epoxy resin, a trifunctional epoxy resin, a tetrafunctional epoxy resin and a mixture thereof.

4. The composition of claim 1, wherein the curable resin is an acrylic resin.

5. The composition of claim 1, wherein the curable resin is a polyurethane/polyurea resin.

6. The composition of claim 1, wherein the surface modifying agent is a reactive siloxane having a formula (3) or (4) 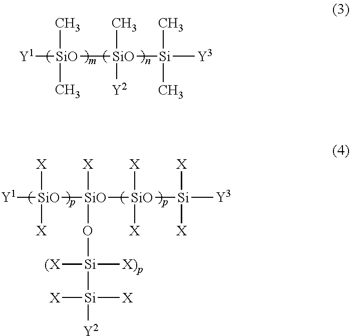
wherein each X is independently an alkyl, aryl or cycloalkyl group, each of Y¹, Y² and Y³ is independently X or a reactive group comprising an amino group, an epoxy group, an anhydride group, an acrylate group or a perfluoro group provided that at least one of Y¹, Y² or Y³ is not X, m is a number from about 1 to about 10000, n is a number from 0 to about 10, and each p is independently a number from 0 to about 1000 provided that at least one p is at least about 10.

7. The composition of claim 6, wherein X is methyl.

8. The composition of claim 7, wherein at least one of Y¹, Y² and Y³ is an amino group.

9. The composition of claim 7, wherein at least one of Y¹, Y² and Y³ is an epoxy group.

10. The composition of claim 7, wherein at least one of Y¹, Y² and Y³ is an acrylate group.

11. The composition of claim 7, wherein at least one of Y¹, Y² and Y³ is a perfluoro group.

12. The composition of claim 1, wherein the surface modifying agent is a reactive fluoro compound having a formula R¹⁰—CF₃ where R₁₀ is CH₂═CR₁₁COOR₁₂—, R¹¹ is hydrogen or an alkyl group having 1 to 3 carbon atoms and R¹² is an alkyl group having 1 to 6 carbon atoms.

13. The composition of claim 1, wherein the surface modifying agent is a reactive fluoro compound having formula R¹³—R^{f}—R¹³ where R¹³ is CH₂═CR₁₄COO—, R¹⁴ is hydrogen or an alkyl group having 1 to 3 carbon atoms and R_{f} is a compound selected from the group of (a) to (e) 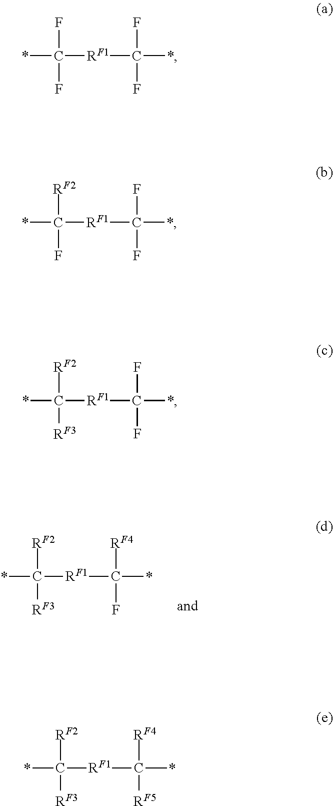
where * is a bonding site to R¹³, R^{F1} is a perfluoroalkyl group having 1 to 14 carbon atoms and R^{F2}, R^{F3}, R^{F4}, and R^{F5} are each independently hydrogen or a perfluoroalkyl group having 1 to 14 carbon atoms.

14. The composition of claim 1, wherein the surface modifying agent is present in an amount of between about 0.0001 wt. % to about 8.0 wt. %, based on the total weight of the composition.

15. The composition of claim 1, further comprising at least one of a rheology modifying agent or a toughening agent.

16. A laminate structure comprising a first substrate bonded to a second substrate and a cured structural adhesive film between the first and second substrates, wherein the structural adhesive film is formed from the composition of claim 1.

17. The laminate structure of claim 16, wherein the first substrate and the second substrate are independently selected from a metal, a composite material, a ceramic, and a thermoplastic.

18. A method of bonding a first substrate to a second substrate comprising applying the composition of claim 1 to a surface of at least one of the first substrate and the second substrate to form an adhesive film on the surface, contacting the first substrate and the second substrate such that the adhesive film is therebetween and curing the adhesive film to form an adhesive bond between the first substrate and the second substrate.

19. The method of claim 18, wherein the first substrate and the second substrate are independently selected from a metal, a composite material, a ceramic, and a thermoplastic.
